(19) United States
(12) Patent Application Publication
(10) Pub. No.: US 2011/0032181 A1
(43) Pub. Date: Feb. 10, 2011

(54) DISPLAY DEVICE AND CONTROL METHOD UTILIZING THE SAME

(75) Inventors: Lita CHIANG, Taipei (TW); Shou-Te WEI, Hsinchu City (TW)

Correspondence Address: Wang Law Firm, Inc., 4989 Peachtree Parkway,, Suite 200, Norcross, GA, 30092, US

(73) Assignee: uPI Semiconductor Corporation, Taipei (TW)

(21) Appl. No.: 12/537,239

(22) Filed: Aug. 6, 2009

(51) Int. Cl. G09G 5/00

(52) U.S. Cl. 345/156

(57) ABSTRACT

A display device controlled by an indicator device having a first light-spot is disclosed. The display device includes a first camera, a panel, and a processing unit. The first camera detects the first light-spot for generating a first detection signal. The panel displays a cursor. The processing unit controls the cursor according to the first detection signal. When the distance between the first camera and the first light-spot is a first length and the moving distance of the first light-spot is a first distance, the moving distance of the cursor is a second distance. When the distance between the first camera and the first light-spot is a second length and the moving distance of the first light-spot is the first distance, the moving distance of the cursor is the second distance.

### BACKGROUND OF THE INVENTION

1. Field of the Invention

The invention relates to a display device, and more particularly to a display device comprising a camera.

2. Description of the Related Art

With technological development, functions and types of display devices have increased. The display device may comprise a sound adjustment function, a language adjustment function, a resolution adjustment function and so on. Generally, a user presses a function key on a remote controller of the display device to select the required function, which is inconvenient for users.

### BRIEF SUMMARY OF THE INVENTION

A control method and a display device are provided. An exemplary embodiment of a control method for a display device displaying a cursor is described in the following. A first light-spot is detected to generate a first detection signal. The cursor is controlled according to the first detection signal. When the distance between the display device and the first light-spot is a first length and the moving distance of the first light-spot is a first distance, the moving distance of the cursor is a second distance. When the distance between the display device and the first light-spot is a second length and the moving distance of the first light-spot is the first distance, the moving distance of the cursor is the second distance.

An exemplary embodiment of a display device, which is controlled by an indicator device having a first light-spot, comprises a first camera, a panel and a processing unit. The first camera detects the first light-spot for generating a first detection signal. The panel displays a cursor. The processing unit controls the cursor according to the first detection signal.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1A is a schematic diagram of an electronic system of the invention;

FIG. 1B is an exemplary embodiment of the electronic system of the invention;

FIG. 2 is another schematic diagram of an electronic system of the invention;

FIG. 3A is another schematic diagram of an electronic system of the invention;

FIG. 3B is another exemplary embodiment of the electronic system of the invention;

FIG. 4 is a flowchart of an exemplary embodiment of a control method of the invention; and

FIGS. 5-7 are flowcharts of other exemplary embodiments of the control method of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

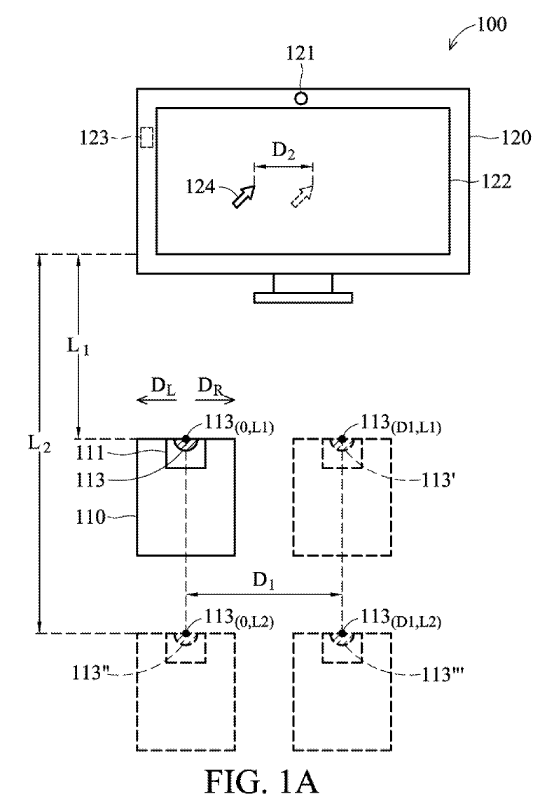

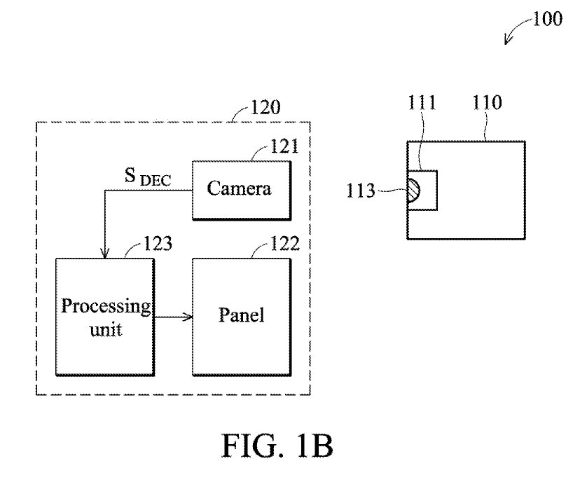

FIG. 1A is a schematic diagram of an electronic system. The electronic system 100 comprises an indicator device 110 and a display device 120. The indicator device 110 may be a remote controller. The remote controller can turn on or off the display device 120. In this embodiment, the indicator device 110 comprises an illumination unit 111. The illumination unit 111 is illuminated to generate a light-spot 113. The illumination unit 111 may be a light emitting diode (LED) or other illuminative elements.

The display device 120 comprises a camera 121, a panel 122, and a processing unit 123. The camera 121 captures an image. The processing unit 123 controls the position of the cursor 124 on the panel 122 according to the captured image. In this embodiment, the camera 121 captures the light-spot 113. Thus, the processing unit 123 controls the moving position of the cursor 124 according to the moving distance of the light-spot 113.

For example, when the light-spot 113 moves according to the direction D_{R}, the cursor 124 is also moved according to the direction D_{R}. Similarly, when the light-spot 113 moves according to the direction D_{L}, the cursor 124 also moves according to the direction D_{L}. Thus, a user can utilize the indicator device 110 to set the position of the cursor 124 on the panel 122.

Assume that the primary position of the light-spot 113 is defined as 113_{(0, L1)}. Since the distance between the light-spot 113 and the display device 120 is L₁, if the light-spot 113 is moved according to the direction D_{R} and the moving distance of the light-spot 113 is D₁, the new light-spot 113 is referred to the light-spot 113′ and the position of the light-spot 113′ is defined as 113_{(D1, L1)}. When the distance between the light-spot 113 and the display device 120 is changed from L₁ to L₂, the new light-spot 113 is referred to the light-spot 113″ and the position of the light-spot 113″ is defined as 113_{(0, L2)}. Since the distance between the light-spot 113″ and the display device 120 is L₂, if the light-spot 113″ is moved according to the direction D_{R} and the moving distance of the light-spot 113″ is D₁, the now light-spot 113″ is referred to the light-spot 113′″ and the position of the light-spot 113′″ is defined as 113_{(D1, L2)}.

In this embodiment, when the distance between the light-spot 113 and the display device 120 becomes longer or shorter, if the moving distance of the light-spot 113 is constant, the moving distance of the cursor 124 displayed on the panel 122 is fixed. For example, assume that the moving distance of the cursor 124 is D₂ when the distance between the light-spot 113 and the display device 120 is L₁ and the moving distance of the light-spot 113 is D₁, when the distance between the light-spot 113 and the display device 120 is changed from L₁ to L₂ and the moving distance of the light-spot 113 is maintained at D₁, the moving distance of the cursor 124 is fixed at D₂.

Referring to FIG. 1A, assume that the distance L₁ is 100 cm, the moving distance D₁ of the light-spot 113 is 10 cm and the cursor 124 displayed on the panel 122 is 2 cm. If the distance between the light-spot 113 and the display device 120 is changed from L₁ to L₂ (e.g. 150 cm), when the light-spot 113 moves 10 cm, the cursor 124 displayed on the panel 122 still moves 2 cm.

FIG. 1B is an exemplary embodiment of the electronic system. The camera 121 captures the light-spot 113 and generates a detection signal S_{DEC} according to the captured result. In one embodiment, the detection signal S_{DEC} refers to the dimension of the light-spot 113. Thus, the distance between the light-spot 113 and the display device 120 is obtained according to the detection signal S_{DEC}. Further, the camera 121 comprises a capturing module (not shown) to capture the light-spot 113. The capturing module can be a charge coupled device (CCD) or a complementary metal-oxide semiconductor (CMOS).

Note that the invention does not limit the position of the camera 121. Referring to FIG. 1A, the camera 121 is disposed over the panel 122. In other embodiments, the camera 121 is disposed under the panel 122 or disposed in the left-side or the right-side of the panel 122. Additionally, the camera 121 comprises a zoom lens to utilize the different focal to generate the detection signal S_{DEC}.

The processing unit 123 utilizes the detection signal S_{DEC} to control the position of the cursor 124 displayed on the panel 122. In other embodiments, the processing unit 123 further utilizes another detection signal to control the cursor 124. For example, when the camera 121 captures a face, the processing unit 123 further utilizes the proportion of the captured face to control the position of the cursor 124 displayed on the panel 122. The captured face is referred to as another detection signal.

The relative position of the light-spot 113 is estimated by the processing unit 123. If the processing unit 123 controls the cursor 124 according to the estimated result, the moving distance of the cursor 124 is constant when the distance between the light-spot 113 and the display device 120 is changed and the moving distance of the light-spot 113 is constant.

For example, when the indicator device 110 approaches the display device 120, the captured image captured by the camera 121 becomes bigger. Oppositely, when the indicator device 110 leaves the display device 120, the captured image captured by the camera 121 becomes smaller. Thus, the processing unit 123 is capable of estimating the relative distance between the indicator device 110 and the display device 120 according to the captured result generated by the camera 121.

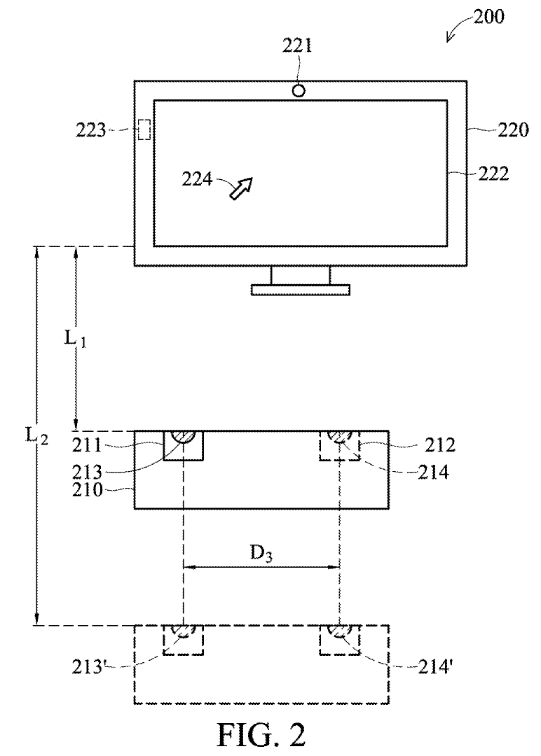

FIG. 2 is another schematic diagram of an electronic system. FIG. 2 is similar to FIG. 1A with the exception of the indicator device 210. Referring to FIG. 2, the indicator device 210 comprises the illumination units 211 and 212. The illumination unit 211 is illuminated to generate the light-spot 213. The illumination unit 212 is illuminated to generate the light-spot 214. The light-spots 213 and 214 are separated by a distance D₃.

Referring to FIG. 2, the camera 221 captures the light-spots 213 and 214 and obtains the distance D₃ according to the captures light-spots 213 and 214. The camera 221 generates a detection signal according to the obtained distance D₃. For example, when the distance between the indicator device 210 and display device is L₁, the camera 221 captures the light-spots 213 and 214 and obtains the distance D₃ according to the captures light-spots 213 and 214. The camera 221 generates a first detection result according to the obtained distance D₃. When the distance between the indicator device 210 and display device is changed from L1 to L₂, the camera 221 captures the light-spots 213′ and 214′ and obtains the distance D₃ according to the captures light-spots 213′ and 214′. The camera 221 generates a second detection result according to the obtained distance D₃.

In one embodiment, the second detection result may be less than the first detection result. The processing unit 223 estimates the relative distance between the indicator device 210 and the display device 220 according to the first and the second detection results. The processing unit 223 controls the cursor 224 according to the estimated result. Thus, the moving distance of the cursor 224 is constant when the distance between the indicator device 210 and the display device 220 is changed and the moving distance of the indicator device 210 is constant.

In this embodiment, the camera 221 utilizes the same focal to capture the distance D₃ when the distance between the indicator device 210 and the display device 220 is changed. In other embodiments, the camera 221 utilizes the different focal to capture the distance D₃. For example, the camera 221 utilizes a first focal for generating a first detection result when the distance between the indicator device 210 and the display device 220 is L₁. The camera 221 utilizes a second focal to capture the distance D₃ for generating a second detection result when the distance between the indicator device 210 and the display device 220 is changed from L₁ to L₂.

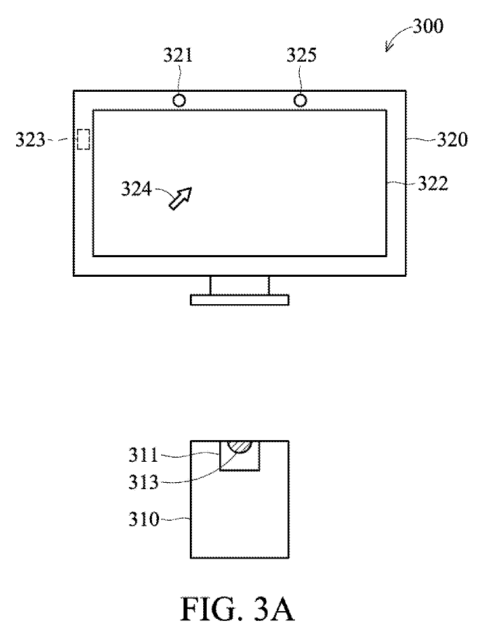

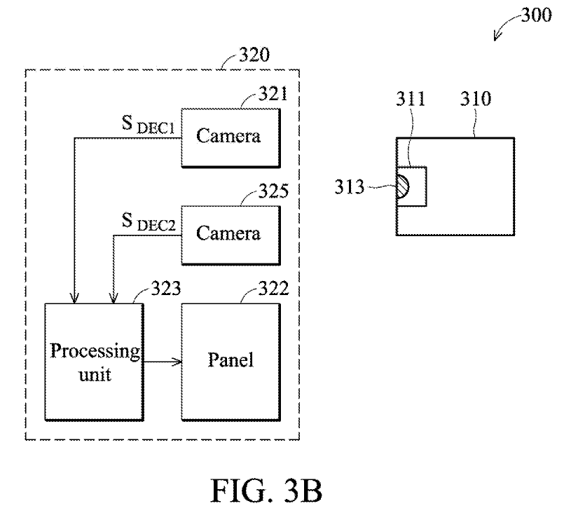

FIG. 3A is another schematic diagram of an electronic system. FIG. 3A is similar to FIG. 1A with the exception that the display device 320 comprises the cameras 321 and 325. FIG. 3B is another exemplary embodiment of the electronic system. The camera 321 captures the light-spot 313 and generates a detection signal S_{DEC1} according to the captured result. The camera 325 captures the light-spot 313 and generates another detection signal S_{DEC2} according to the captured result generated by the camera 325. In this embodiment, the camera 321 and 325 are on the same horizon. Namely, the distance between the camera 321 and the ground is the same as that the distance between the camera 325 and the ground.

In this embodiment, the processing unit 323 estimates the absolute distance between the indicator device 310 and the display device 320 according to the detection signals S_{DEC1} and S_{DEC2}. The processing unit 323 utilizes the estimated result to control the cursor 324 such that the moving distance of the cursor 324 is constant when the distance between the indicator device 310 and the display device 320 is changed and the moving distance of the light-spot 313 is constant. In one embodiment, the processing unit 323 utilizes a triangulation method to process the detection signals S_{DEC1} and the S_{DEC2} for obtaining the real 3D position of the light-spot 313.

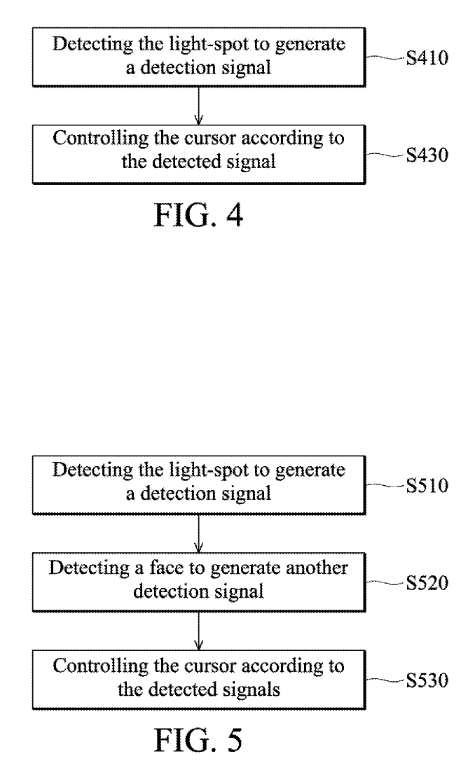

FIG. 4 is a flowchart of an exemplary embodiment of a control method. The control method shown in FIG. 4 is applied to a display device. The display device displays a cursor. A light-spot is detected to generate a detection signal (step S410). In one embodiment, a camera is utilized to detect and capture the light-spot. Further, the light-spot is generated by an indicator device. In this embodiment, the detection signal corresponds to the dimension of the light-spot.

The position of the curve displayed on the display device is controlled according to the detection signal generated by the step S410 (step S430). In this embodiment, assume that when the distance between the light-spot and the display device is a first length and the moving distance of the light-spot is a first distance (e.g. D₁), the moving distance of the cursor displayed on the display device is a second distance. When the distance between the light-spot and the display device is changed from the first distance to a second distance and the moving distance of the light-spot moves is constant (i.e. D₁), the moving distance of the cursor is maintained to the second distance.

Referring to FIG. 1A, assume that the length L₁ is 100 cm, the moving distance D₁ of the light-spot 113 is 10 cm, and the moving distance of the cursor 124 displayed on the display device 120 is 2 cm. When the distance between the light-spot 113 and the display device 120 is changed from 100 cm to 150 cm, if the moving distance (D₁) of light-spot 113″ is constant (i.e. 10 cm), the moving distance of the cursor 124 is constant to 2 cm. Thus, the moving distance of the cursor displayed on the display device is constant when the distance between the light-spot and the display device is changed and the moving distance of the light-spot is constant.

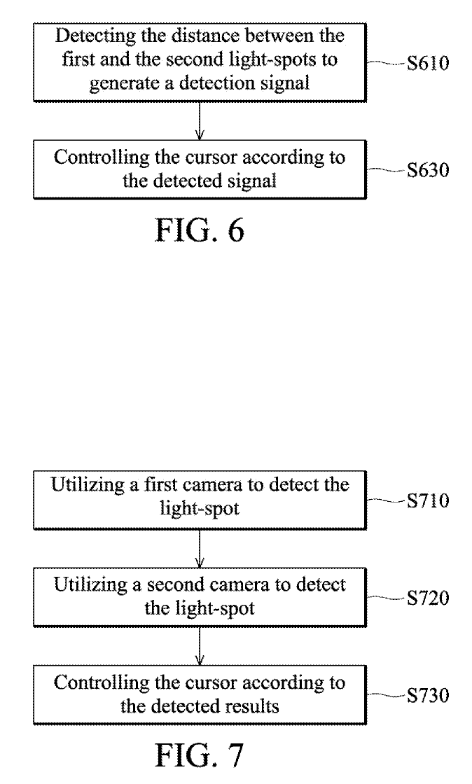

FIG. 5 is a flowchart of another exemplary embodiment of the control method. FIG. 5 is similar to FIG. 4 with the exception that the control method as shown in FIG. 5 further detects a face to generate another detection signal. A detection signal is a result of detecting the light-spot and is referred to as a first detection signal. Another detection signal is a result of detecting the face and is referred to as a second detection signal. If the detection signals are utilized to control the position of the cursor, the moving distance of the cursor is constant when the distance between the light-spot and the display device is changed and the moving distance of the light-spot is constant.

FIG. 6 is a flowchart of another exemplary embodiment of the control method. FIG. 6 is similar to FIG. 4 with the exception that the step 610 detects a distance between a first light-spot and a second light-spot. The detection result is utilized to control the cursor. In this embodiment, the first and the second light-spots are simultaneously disposed in an indicator device, as shown in FIG. 2. The relative distance between the indicator device and the display device can be estimated according to the detection result (i.e. the distance D₃). In the step S630, the cursor is controlled according to the estimated result. Thus, the moving distance of the cursor is constant when the distance between the light-spot and the display device is changed and the moving distance of the light-spot is constant.

FIG. 7 is a flowchart of another exemplary embodiment of the control method. A light-spot is detected to generate a first detection signal (step S710). In one embodiment, the light-spot is detected and captured by a first camera. The light-spot is detected and captured again to generate a second detection signal (step S720). In one embodiment, a second camera is utilized to again detect and capture the light-spot. In this embodiment the different cameras are utilized to detect the light-spot. In one embodiment, the first camera utilizes a first focal to detect the light-spot and the second camera utilizes a second focal to detect the light-spot, wherein the first focal differs from the second focal.

The absolute distance between the light-spot and the display device is estimated according to the first and the second detection signal. If the estimated result is utilized to control the cursor, the moving distance of the cursor is constant when the distance between the indicator device and the display device is changed and the moving distance of the light-spot is constant.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device controlled by an indicator device comprising a first light-spot, comprising:
a first camera detecting the first light-spot for generating a first detection signal;
a panel displaying a cursor; and
a processing unit controlling the cursor according to the first detection signal, wherein when the distance between the first camera and the first light-spot is a first length and the moving distance of the first light-spot is a first distance, the moving distance of the cursor is a second distance, and when the distance between the first camera and the first light-spot is a second length and the moving distance of the first light-spot is the first distance, the moving distance of the cursor is the second distance.

2. The display device as claimed in claim 1, wherein when a face is detected by the first camera, the processing unit further utilizes the proportion of the face to control the cursor.

3. The display device as claimed in claim 1, wherein the first camera generates the first detection signal according to the size of the first light-spot.

4. The display device as claimed in claim 1, wherein the indicator device further comprises a second light-spot, and the first camera detects the distance between the first and the second light-spots to generate the first detection signal.

5. The display device as claimed in claim 4, wherein when the distance between the first camera and the first light-spot is the first length, the first camera utilizes a first focal to detect the distance between the first and the second light-spots, and when the distance between the first camera and the first light-spot is the second length, the first camera utilizes a second focal to detect the distance between the first and the second light-spots.

6. The display device as claimed in claim 1, further comprising a second camera, wherein the second camera detects the first light-spot for generating a second detection signal, and the processing unit controls the cursor by the second detection signal.

7. The display device as claimed in claim 6, wherein the distance between the first camera and a floor is the same as the distance between the second camera and the floor.

8. The display device as claimed in claim 6, wherein the processing unit processes the first and the second detection signals by triangulation.

9. An electronic system, comprising:
an indicator device having a first light-spot, and
a display device comprising:
a first camera detecting the first light-spot for generating a first detection signal;
a panel displaying a cursor; and
a processing unit controlling the cursor according to the first detection signal, wherein when the distance between the first camera and the first light-spot is a first length and the moving distance of the first light-spot is a first distance, the moving distance of the cursor is a second distance, and when the distance between the first camera and the first light-spot is a second length and the moving distance of the first light-spot is the first distance, the moving distance of the cursor is the second distance.

10. The electronic system as claimed in claim 9, wherein when a face is detected by the first camera, the processing unit further utilizes the proportion of the face to control the cursor.

11. The electronic system as claimed in claim 9, wherein the first camera generates the first detection signal according to the size of the first light-spot.

12. The electronic system as claimed in claim 9, wherein the indicator device further comprises a second light-spot, and the first camera detects the distance between the first and the second light-spots to generate the first detection signal.

13. The electronic system as claimed in claim 12, wherein when the distance between the first camera and the first light-spot is the first length, the first camera utilizes a first focal to detect the distance between the first and the second light-spots, and when the distance between the first camera and the first light-spot is the second length, the first camera utilizes a second focal to detect the distance between the first and the second light-spots.

14. The electronic system as claimed in claim 9, wherein the display device further comprises a second camera detecting the first light-spot to generate a second detection signal, and the processing unit controls the cursor by the second detection signal.

15. The electronic system as claimed in claim 14, wherein the distance between the first camera and a floor is the same as the distance between the second camera and the floor.

16. The electronic system as claimed in claim 14, wherein the processing unit processes the first and the second detection signals by triangulation.

17. A control method for a display device displaying a cursor, comprising:
detecting a first light-spot to generate a first detection signal; and
controlling the cursor according to the first detection signal,
wherein when the distance between the display device and the first light-spot is a first length and the moving distance of the first light-spot is a first distance, the moving distance of the cursor is a second distance, and when the distance between the display device and the first light-spot is a second length and the moving distance of the first light-spot is the first distance, the moving distance of the cursor is the second distance.

18. The control method as claimed in claim 17, further comprising:
detecting a face for generating a second detection signal; and
controlling the cursor according to the first and the second detection signals.

19. The control method as claimed in claim 17, wherein the first detection signal corresponds to the size of the first light-spot.

20. The control method as claimed in claim 17, wherein the first detection signal corresponds to the distance between the first light-spot and a second light-spot.
